(19) United States
(12) Patent Application Publication
(10) Pub. No.: US 2023/0342696 A1
(43) Pub. Date: Oct. 26, 2023

(54) SYSTEM AND METHOD FOR AI-BASED SUGGESTIONS

(71) Applicant: Verizon Patent and Licensing Inc., Basking Ridge, NJ (US)

(72) Inventors: Bharatwaaj Shankar, Chennai (IN); Eswar P. Somarouthu, Hyderabad (IN); Pothireddy Munemma, Hyderabad (IN); Vinoth Kuppathamottur Ghanappan, Tamilnadu (IN)

(21) Appl. No.: 17/725,736

(22) Filed: Apr. 21, 2022

(51) Int. Cl. G06Q 10/06; H04L 41/0894

(52) U.S. Cl. CPC G06Q 10/06375; G06Q 10/06315; H04L 41/0894

(57) ABSTRACT

A framework uses artificial intelligence to provide suggestions for minimizing stagnant resources in contracts across multiple business relationships. A network device receives multiple smart contracts governing relationships between a telecommunications carrier and partner entities; extracts delivery timelines from the multiple smart contracts; generates an embedding layer based on historical vendor data, in-house procedural data; predicts one or more windows of stagnant resources in the delivery timelines; and generates a policy suggestion to optimize stagnant resources during the one or more windows.

### BACKGROUND

Machine learning (ML) and artificial intelligence (AI) provide numerous opportunities to address complex problems that would not be possible with previous technologies. ML and AI may be applied to optimize the use of resources in large organizations, such as a telecommunications carrier that provides telecommunication services.

### BRIEF DESCRIPTION OF THE DRAWINGS

FIG. 1 is a diagram that depicts an exemplary network environment in which systems and methods described herein may be implemented;

FIG. 2 is a diagram illustrating exemplary components of a device that may correspond to the network elements and client devices depicted in the environment of FIG. 1;

FIG. 3 is a block diagram illustrating example logical components of a suggestion system;

FIG. 4 is a block diagram illustrating example logical components of a data tools system;

FIG. 5 is a diagram illustrating communications for providing suggestions in a portion of a network environment according to an implementation described herein; and

FIG. 6 is a flow diagram of an example process for implementing a suggestion system for a telecommunications carrier according to an implementation.

### DETAILED DESCRIPTION OF EXAMPLE EMBODIMENTS

The following detailed description refers to the accompanying drawings. The same reference numbers in different drawings may identify the same or similar elements.

Large organizations, such as telecommunications carriers, typically have multiple relationships with other entities, each involving different supply chains, transactions, services, deliverables, etc. Each relationship may be governed by contracts with different terms and schedules (e.g., delivery schedules, payment schedules, etc.) and may use different third-party institutions (e.g., third-party telecommunications carriers, delivery services, insurance companies, financial institutions, etc.) to support contracted activities. In adhering to the different terms and schedules, a telecommunications carrier may have periods (or windows) where resources are stagnant, such as computing resources that are temporarily unallocated, inventory that is reserved for a future delivery date, or other resources that are reserved for a future period. Accurate predictions of stagnant resources for a single business relationship may provide some opportunities to otherwise utilize such resources. However, more substantial opportunities may become available by forecasting time windows in which resources are stagnant with a high level of confidence across a telecommunications carrier's multiple business relationships.

Systems and methods described herein may use artificial intelligence to provide suggestions for minimizing stagnant resources in contracts across multiple business relationships. According to an implementation, a computing device may receive multiple smart contracts governing relationships between a telecommunications carrier and partner entities. The computing device may extract delivery timelines from the multiple smart contracts and generate an embedding layer based on historical vendor data and in-house procedural data. The computing device may predict one or more windows of stagnant resources in the delivery timelines, based on application of the embedding layer by a machine learning or artificial intelligence system. The computing device may generate a policy suggestion to optimize use of stagnant resources during the one or more windows. When the suggestions are applied, the systems and methods can provide an overall reduction in stagnant resources and/or increased resource utilization rates.

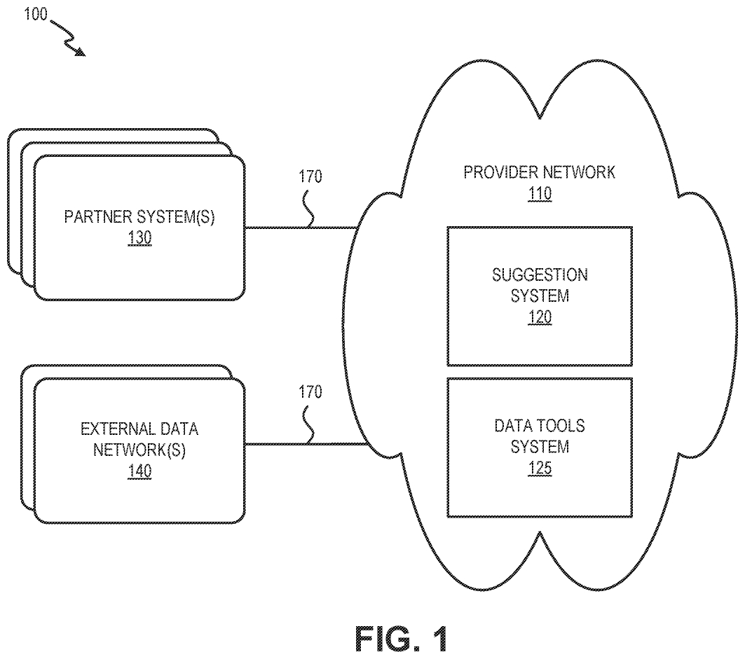

FIG. 1 is a diagram illustrating an exemplary network environment 100 in which systems and methods described herein may be implemented. As illustrated, environment 100 may include a provider network 110 associated with a provider of telecommunications services, one or more vendor networks 130, and one or more external data networks 140.

Provider network 110, vendor networks 130, and external data networks 140 may include one or more network elements or be combined within one or more network elements. A network element may be implemented according to a centralized computing architecture, a distributed computing architecture, or a cloud computing architecture (e.g., an elastic cloud, a private cloud, a public cloud, a virtual cloud etc.). Additionally, a network element may be implemented according to one or multiple network architectures (e.g., a client device, a server device, a peer device, a proxy device, and/or a cloud device).

As further illustrated, network environment 100 includes communication links 170 between the networks. A network element of networks 110, 130, or 140 may transmit and receive data via a link 170. Network environment 100 may be implemented to include wireless and/or wired (e.g., electrical, optical, etc.) links 170. A communication link between network elements may be direct or indirect. For example, an indirect communication link may involve an intermediary device or network element, and/or an intermediary network not illustrated in FIG. 1.

Provider network 110 may include one or multiple networks of one or multiple types that are capable of receiving and transmitting data, voice and/or video signals as part of the telecommunications services it provides to customers. For example, provider network 110 may include one or more public switched telephone networks (PSTNs) or other type of switched network. Provider network 110 may also include one or more wireless networks and may include a number of wireless stations for receiving wireless signals and forwarding the wireless signals toward the intended destination. Provider network 110 may further include one or more satellite networks, one or more packet switched networks, such as an Internet protocol (IP) based network, a software defined network (SDN), a local area network (LAN), a WiFi network, a wide area network (WAN), a long term evolution (LTE) network, a fourth generation (4G) network, a 4G LTE Advanced network, a fifth generation (5G) network, an intranet, the Internet, or another type of network that is capable of transmitting data. Some or all of provider network 110 may include a private domain or virtual private cloud. In some aspects, portions of provider network 110 may provide packet-switched services and wireless Internet protocol (IP) connectivity to user devices to provide, for example, data, voice, and/or multimedia services during communication sessions.

Provider network 110 may further include compute resources, such as cloud compute resources or Multi-access Edge Computing (MEC) compute resources that can provide services for applications and other enhanced services. For example, a customer application may offload compute tasks to a cloud platform or MEC platform that can provide services that are not capable by a local processor in a client device, but can be provided within a timing constraint of the customer application. In some implementation, provider network 110 may reserve and/or allocate compute resources in accordance with contracts with partner systems 130 and/or customers.

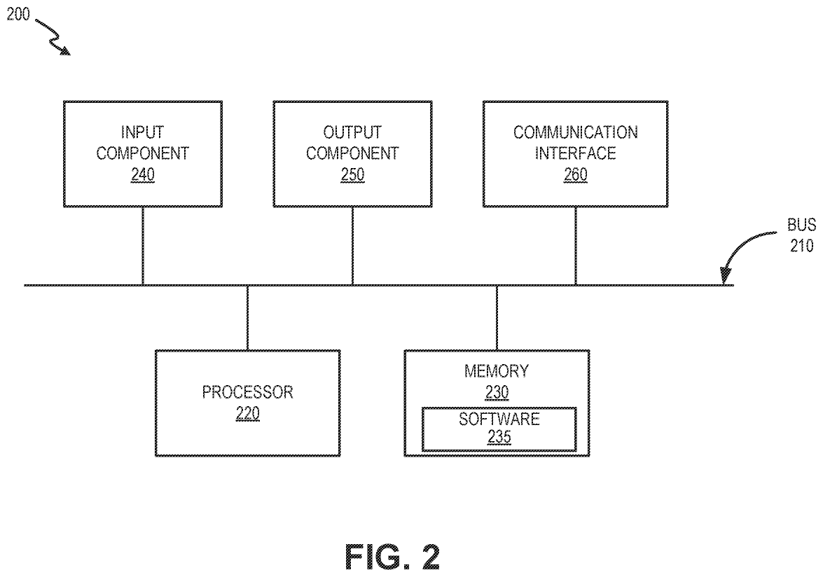

Components of provider network 110 may be implemented as dedicated hardware components, virtual network functions (VNFs), and/or containerized network functions (CNFs), implemented on top of a common shared physical infrastructure using SDN. For example, an SDN controller may implement one or more of the components of provider network 110 using an adapter implementing a VNF virtual machine, a CNF container, an event driven serverless architecture interface, and/or another type of SDN architecture. The common shared physical infrastructure may be implemented using one or more devices 200 described below with reference to FIG. 2 in a cloud computing center or MEC platform associated with provider network 110.

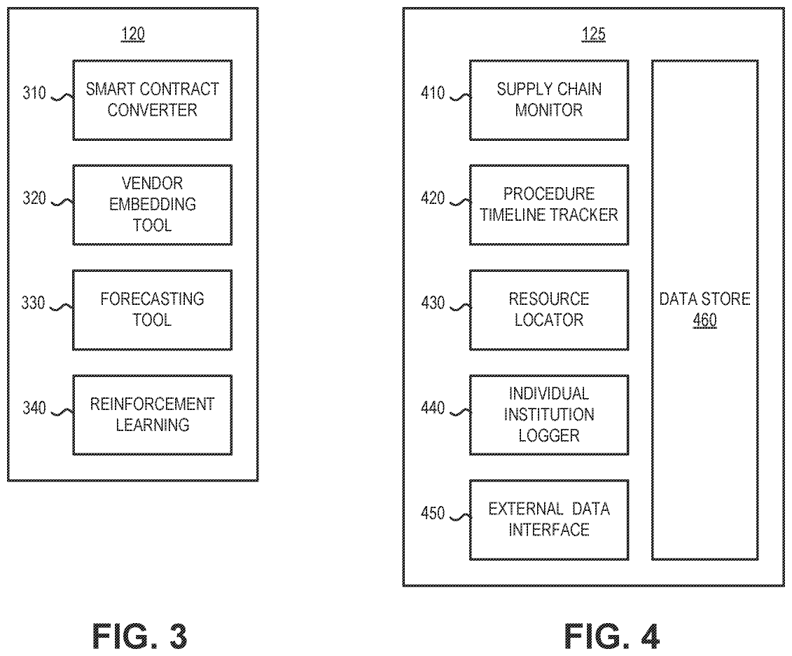

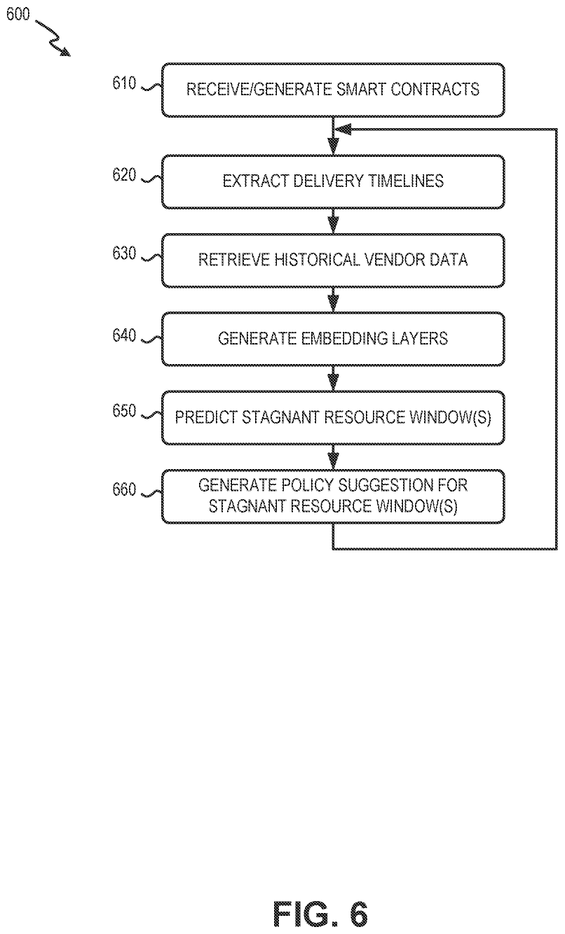

As illustrated in FIG. 1, provider network 110 may include a suggestion system 120 and a data tools system 125. Suggestion system 120 may include one or more computing devices or network devices with artificial intelligence (AI) and/or machine learning (ML) logic to provide control, management, and/or optimization services. Suggestion system 120 may analyze smart contracts that govern relationships between a telecommunications carrier and partner entities. Suggestion system 120 may also analyze historical vendor (or partner) data and in-house procedural data that may be compiled by the telecommunications carrier. Suggestion system 120 may extract timelines from the smart contracts and predict windows of stagnant resources in the timelines, using a machine learning or artificial intelligence system. Suggestion system 120 may review available usage forecasts, benchmarks, and contract bid opportunities, published computing needs, etc., to generate a policy suggestion that optimizes the stagnant resources during one or more of the windows. Suggestion system 120 is described further in connection with, for example, FIGS. 3 and 6.

Data tools system 125 may collect and configure data for use by suggestion system 120. Data tools system 125 may include one or more computing devices, network devices, and/or databases. Data tools system 125 may collect data from in-house systems associated with provider network 110 and external systems. For example, data tools system 125 may collect historical usage and capacity records for compute resources throughout provider network 110, such as MEC-based resource and cloud-based resources. According to an implementation, data tools system 125 may implement a schema to provide a common format data for data from different in-house or external systems. Data tools system 125 is described further in connection with, for example, FIGS. 4 and 6.

Each partner system 130 may include one or more network devices or computing devices. Partner system 130 may represent different vendors or enterprises that support and/or consume services from provider network 110. Entities operating partner systems 130 may have a business relationship with the entity operating provider network 110. For example, partner system 130 may be associated with an entity that provides services or materials for provider network 110. As another example, partner system 130 may be associated with an entity that consumes services provided by provider network 110. According to an implementation, partner system 130 may use one or more APIs or other communication interfaces (referred to herein collectively as APIs) to transmit data to provider network 110 (e.g., via links 170). According to an implementation described herein, each partner system 130 may include one or more devices that provide transaction records, service records, invoices, charging records, disputes, payment logs, and/or other information regarding a business relationship with the entity operating provider network 110.

External data network 140 may include one or multiple networks. For example, data network 140 may be implemented to provide a service or include an application-layer network, the Internet, an Internet Protocol Multimedia Subsystem (IMS) network, a Rich Communication Service (RCS) network, a cloud network, a packet-switched network, or other type of network that hosts an application or service. Depending on the implementation, data network 140 may include various network devices that provide various applications or services (e.g., servers, mass storage devices, data center devices, etc.), and/or other types of network services pertaining to various network-related functions. According to an implementation described herein, data network 140 may include one or more devices that provide contract request for proposals (RFPs), service requests (e.g., for compute services, inventory, etc.), macroeconomic data, microeconomic data, and investment options for use by suggestion system 120. In another implementation, external data network 140 may include one or more platforms to enable transactions, auctions, and exchanges between buyers and sellers of compute resources. For example, some computing devices may interface with data network 140 to offer secure cloud compute services as sellers. Similarly, other computing devices may interface with data network 140 to solicit secure cloud compute exchanges as buyers.

The number of network elements, the number of networks, and the arrangement in environment 100 are exemplary. According to other embodiments, environment 100 may include additional network elements, fewer network elements, and/or differently arranged network elements, than those illustrated in FIG. 1. For example, there may be multiple partner systems 130 that participate in performing network functions in environment 100 and use/provide services of provider network 120. Additionally, or alternatively, according to other embodiments, multiple network elements may be implemented on a single device, and conversely, a network element may be implemented on multiple devices.

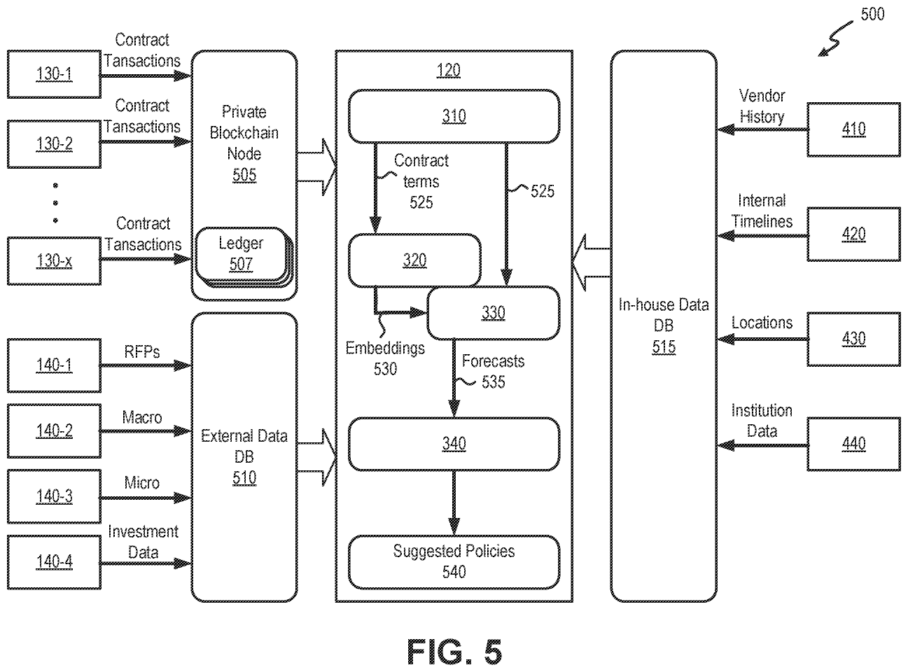

FIG. 2 is a diagram illustrating exemplary physical components of a device 200. Device 200 may correspond to each of the network elements of FIG. 1, including devices in provider network 110, partner system 130, and external data network 140. Device 200 may include a bus 210, a processor 220, a memory 230 with software 235, an input component 240, an output component 250, and a communication interface 260. Bus 210 may include a path that permits communication among the components of device 200. Processor 220 may include a processor, a microprocessor, or processing logic that may interpret and execute instructions. Memory 230 may include any type of dynamic storage device that may store information and instructions, for execution by processor 220, and/or any type of non-volatile storage device that may store information for use by processor 220. Software 235 includes an application or a program that provides a function and/or a process. Software 235 may also include firmware, middleware, microcode, hardware description language (HDL), and/or other form of instruction. By way of example, with respect to the network elements that include logic to provide blockchain services or machine learning, these network elements may be implemented to include software 235. Additionally, for example, suggestion system 120 may include software 235 (e.g., an application to communicate with devices/systems, etc.) to perform tasks as described herein. Input component 240 may include a mechanism that permits a person to input information to device 200, such as a keyboard, a keypad, a button, a switch, etc. Output component 250 may include a mechanism that outputs information to the person, such as a display, a speaker, one or more light emitting diodes (LEDs), a liquid crystal display (LCD), etc. Communication interface 260 may include a transceiver that enables device 200 to communicate with other devices and/or systems via wireless communications, wired communications, or a combination of wireless and wired communications. For example, communication interface 260 may include mechanisms for communicating with another device or system via a network. Communication interface 260 may include an antenna assembly for transmission and/or reception of radio frequency (RF) signals. In one implementation, for example, communication interface 260 may communicate with a network and/or devices connected to a network. Alternatively, or additionally, communication interface 260 may be a logical component that includes input and output ports, input and output systems, and/or other input and output components that facilitate the transmission of data to other devices. Device 200 may perform certain operations in response to processor 220 executing software instructions (e.g., software 235) contained in a computer-readable medium, such as memory 230. A computer-readable medium may be defined as a non-transitory memory device. A non-transitory memory device may include memory space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software. Device 200 may include fewer components, additional components, different components, and/or differently arranged components than those illustrated in FIG. 2. As an example, in some implementations, a display may not be included in device 200. In these situations, device 200 may be a “headless” device that does not include input component 240. As another example, device 200 may include one or more switch fabrics instead of, or in addition to, bus 210. Additionally, or alternatively, one or more components of device 200 may perform one or more tasks described as being performed by one or more other components of device 200. FIG. 3 is a block diagram illustrating example logical components of suggestion system 120. As shown in FIG. 3, suggestion system 120 may include a smart contract convertor 310, a vendor embedding tool 320, a forecasting tool 330, and a reinforcement learning tool 340. Each of smart contract convertor 310, vendor embedding tool 320, forecasting tool 330, and reinforcement learning tool 340 may be implemented as one or more devices 200 or as one or more logical components within a device 200. Smart contract convertor 310 may convert manual (or conventional) contracts to smart contracts. A smart contract may include computer code, on top of a block chain, that implements a set of rules. For example, terms of a manual contract, such as compute requirements (e.g., processing speed, storage, security, etc.), compute resource availability, delivery schedules, payment terms, prices, volume discounts, invoice formats, breach and remediation clauses, etc., may be converted into computer-readable code and populated to a distributed ledger for a private block chain (e.g., a block chain restricted to the contracted parties). The smart contract may reduce disputed terms between contracted parties and provide a more reliable basis upon which to project windows of stagnant resources. Smart contract convertor 310 may include a software template, scripts, and test platform that may be used by network administrators and/or programmers to generate a smart contract that automatically verifies and enforces terms between a telecommunications carrier (e.g., associated with provider network 110) and a vendor (e.g., associated with one or more of partner systems 130). According to an implementation, delivery timelines, such as service periods, invoice dates, payment periods, and penalty clauses, in the smart contracts may be identified by smart contract convertor 310. Vendor embedding tool 320 may anonymize and format in-house data, such as vendor delivery history, vendor payment history, vendor data points, approval timelines, smart contract terms, output from a blockchain (e.g., blockchain node 505 described below), and other data. From the anonymized data, vendor embedding tool 320 may generate an embedding layer. The embedding layer may reduce the dimensionality of the anonymized data while preserving information in the data that can be used for modeling. According to an implementation, vendor embedding tool 320 may convert input data into machine-readable numeric strings that can be used for machine learning. Forecasting tool 330 may include a time-series forecasting library. Forecasting tool 330 may forecast time series data based on an additive model where non-linear trends are fit over daily, weekly, monthly, yearly, and/or seasonal effects. Forecasting tool 330 may take the embedding data from vendor embedding tool 320, along with current supply chain data and/or compute resource data, to forecast future levels of inventory, stock, compute resources, etc., and predict what resources should be available at any of a telecommunications carrier's multiple locations for any given period in the future. Thus, forecasting tool 330 may apply inputs such as historical resource levels and embeddings to generate output. Output may include, for example, a predicted amount of compute resources, inventory level, etc. at any point in time (or over a period of time). Reinforcement learning tool 340 may identify and suggest opportunities to maximize value of a short-term resource level. Based on the inputs from forecasting tool 330 and vendor embedding tool 320, the reinforcement learning tool 340 may learn how to utilize the advances or declines in inventory, computing resources and other resources and suggest a policy to maximize a short-term resource. As an example, reinforcement learning tool 340 may evaluate customer tendencies, compute resources, sales projections, pre-orders, contracted discounts, etc., to provide a recommendation for a paid compute service (e.g., mining, encryption, etc.). In another example, reinforcement learning tool 340 may recommend when service tokens for compute resources could be made available for exchanges, trades, or renumeration. As another example, reinforcement learning tool 340 may identify when a trade exchange (e.g., such as an accounting exchange of credits/debits between contracted parties) may be substituted for at least a portion of a payment transaction (e.g., to preserve a window of stagnant resources). According to an implementation, reinforcement learning tool 340 may comprise a deep learning neural network. In one implementation, reinforcement learning tool 340 may use a combination of a convolutional neural network (CNN) and a Recurrent Neural Network (RNN) for time series predictions. Reinforcement learning tool 340 may be trained to maximize profit (e.g., over a quarterly, annual basis, etc.). In another implementation, reinforcement learning tool 340 may be applied to inventory totals and distribution to minimize storage fees, taxes, etc. In one implementation, reinforcement learning tool 340 may suggest, from available opportunities, an investment of resources with a highest guaranteed return during one or more windows. In another implementation, reinforcement learning tool 340 may be configured to exclude suggestions with potential for losses or contract breaches. The logical components shown in FIG. 3 are examples. According to other embodiments, suggestion system 120 may include additional components, fewer components, and/or different components, than those illustrated in FIG. 3 to accomplish similar objectives. For example, one or more of smart contract convertor 310, vendor embedding tool 320, forecasting tool 330, and reinforcement learning tool 340 may be combined with other systems within or outside of provider network 110 as part of one or more network devices. FIG. 4 is a block diagram illustrating example logical components of data tools system 125. As shown in FIG. 4, data tools system 125 may include a supply chain monitor 410, procedure timeline tracker 420, resource locator 430, individual institution data 440, an external data interface 450, and a data store 460. Each of supply chain monitor 410, procedure timeline tracker 420, resource locator 430, individual institution data 440, external data interface 450, and data store 460 may be implemented as one or more devices 200 or as one or more logical components within a device 200. Supply chain monitor 410 may incorporate data from one or more internal or vendor inventory systems. Supply chain monitor 410 may include current and historical production capacities, backlogs, delivery schedules, payment timelines, pre-orders, etc. Supply chain monitor 410 may use APIs or structured interfaces to accept data from multiple different in-house systems (e.g., billing systems, charging systems, inventory systems, data collection systems, etc.) for the telecommunications carrier. Supply chain monitor 410 may store (e.g., in data store 460) data for use by forecasting tool 330 and/or reinforcement learning tool 340 to develop and improve policy models. Procedure timeline tracker 420 may extract lead time information for events that may impact time windows. Procedure timeline tracker 420 may identify internal processing timeframes based on the in-house procedural data, such as orchestration lead times, transaction approval periods, delivery estimates, payment transfer windows, and billing cycles, etc. Procedure timeline tracker 420 may, for example, include internal process times and other external lead times that may impact time windows. Procedure timeline tracker 420 may provide data to data store 460. Resource locator 430 may include data reflective of individual locations (e.g., MEC locations, data centers, retail stores, regional facilities, warehouses, etc.) where computer resources and/or inventory for the telecommunications carrier may be stored or delivered. Resource locator 430 may provide breakdowns of where and how many of a certain type of product or resource may be available, allowing suggestion system 120 to account for latency, transfer times, and deliveries underlying consolidated totals. Resource locator 430 may monitory physical resources (e.g., hardware, inventory, etc.) and/or virtual resources (processing capacity, storage, etc.). Resource locator 430 may provide data to data store 460. Individual institution logger 440 may include breakdown of account totals by individual institutions. For example, individual institution logger 440 may identify account balances (current and historical) for the telecommunications carrier at different third-party institutions. Individual institution logger 440 may also compile consolidated totals of account levels. Individual institution logger 440 may provide data to data store 460. External data interface 450 may collect and compile contract RFPs and service requests, macroeconomic data, microeconomic data, and investment options from external sources. Examples of RFPs and service requests may include private or government requests for services, such as compute services, posted service requests on an exchange, or other compute service solicitations. Examples of macroeconomic data may include inflation rate, gross domestic product, national income, and unemployment levels. Examples of microeconomic data may include quantity of the commodities, production values, commodities price, consumer demand, etc. Examples, of investment and debt options may include savings rates, investment instruments, lending rates, lending instruments, etc., from different financial institutions. External data interface 450 may collect data from designated RSS feeds, web services, or other network devices. External data interface 450 may provide data to data store 460. Data store 460 may store data from supply chain monitor 410, procedure timeline tracker 420, resource locator 430, individual institution logger 440, and external data interface 450. Data store 460 may include a database or another type of data storage (e.g., a table, a list, a flat file, etc.). Data from data store 460 may be used by suggestion system 120. The logical components shown in FIG. 4 are examples. According to other embodiments, data tools system 125 may include additional components, fewer components, and/or different components, than those illustrated in FIG. 4 to accomplish similar objectives. For example, one or more of supply chain monitor 410, procedure timeline tracker 420, resource locator 430, individual institution data 440, and external data interface 450 may be combined with other systems within or outside of provider network 110 as part of one or more network devices. FIG. 5 is a diagram illustrating communications for providing policy suggestions for stagnant resources in a portion 500 of network environment 100 according to an implementation described herein. As shown in FIG. 5, network portion 500 may include suggestion system 120, partner systems 130-1 through 130-x, external data networks 140-1 through 140-4, a private blockchain node 505, an external data database (DB) 510, and an in-house data DB 515. Private blockchain node 505 may include one or more computing devices or network devices to maintain a distributed blockchain ledger 507. Each ledger 507 may include a continuously growing list of records which may be associated with transactions between particular participants (e.g., provider network 110 and a partner system 130) and which is secured from tampering and revision. For example, private blockchain node 505 may log transactions (e.g., for physical equipment, monetary exchanges, services, write-offs, etc.) between a telecommunications carrier of provider network 110 and a partner system 130. Any validated updates from a trusted node (e.g., node 505 or a corresponding node from a partner system 130) will be added into blockchain ledger 507. Each version of blockchain ledger 507 may contain, for example, a timestamp and a link to a previous version of the ledger. Private blockchain node 505 may be implemented using one or more blockchain frameworks, such as Hyperledger Fabric. The blockchain framework ensures transactions' consistency and mutual trust among blockchain network partners (e.g., other trusted nodes) and trade participating parties on the network. Distributed blockchain ledger 507 may replicate transactions across the network. Before committing any transactions, each transaction will go through rigorous scrutiny with contract validation on each node 505/partner to ensure rules and protocols are followed to commit the transactions. According to an implementation, suggestion system 120 may establish a separate ledger 507 with each partner system 130. Ledger 507 may alleviate conflicts/discrepancies by providing data transparency and data integrity assurances to all parties involved within the contracted relationship. According to one implementation, some terms from ledger 507 may be used to generate smart contracts (e.g., smart contracts 520) for suggestion system 120. External data DB 510 may format and store information collected from external data networks 140. External data DB 510 may correspond, for example, to a portion of data store 460. According to an implementation, one or more data networks 140 (e.g., data network 140-1) may provide RFPs or requests for services (e.g., related to opportunities to provide compute services, etc.). Another of data networks 140 (e.g., data network 140-2) may provide macro-economic data. Another of data networks 140 (e.g., data network 140-3) may provide microeconomic data. Another of data networks 140 (e.g., data network 140-4) may provide investment and debt options. As described further below, information from external data DB 510 may be used by forecasting tool 330, for example. In-house data DB 515 may format and store data from various private/proprietary sources. In-house data DB 515 may correspond, for example, to a portion of data store 460. According to an implementation, in-house data DB 515 may receive and store formatted historical vendor data (e.g., from supply chain history 350) for individual vendors. In-house data DB 515 may also receive and store formatted internal procedure data (e.g., from procedure timelines 360). In-house data DB 515 may receive and store formatted location data (e.g., from inventory location data 370) and institution data (e.g., from individual institution data 380). In operation, suggestion system 120 (e.g., smart contract converter 310) may compile smart contracts from private blockchain 505 and/or other partner system contract data. The smart contracts may include digitized contract terms 525 for each of the multiple partner systems 130. Terms of smart contracts 525 may be analyzed against each other and the collected in-house data to identify windows that could be utilized/optimized (e.g., windows of available compute resources, windows of excess inventory. Based on data from external DB 510 and in-house DB 515, suggestion system 120 (e.g., vendor embedding tool 320) may capture different vendor and historical data to generate limited number of data points, referred to herein as embeddings 530. Suggestion system 120 (e.g., forecasting tool 330) may apply embeddings 530 to build forecasts 535 of incoming and outgoing inventory/cash flow, for example, based on schedules in contract terms 525, vendor histories (e.g., from in-house DB 515), etc. According to an implementation, forecasting tool 330 may identify one or more stagnant windows of resources. For example, forecasting tool 330 may identify overlapping payment and debit periods among the same and/or multiple vendors to predict periods/amounts of stagnant inventory, digital tokens, or unused compute resources for the telecommunications carrier. Suggestion system 120 (e.g., reinforcement learning tool 340) may identify suggestions to optimize/monetize available stagnant windows. For example, reinforcement learning tool 340 apply information from external data DB 510 to a predicted stagnant window to identify an opportunity to monetize available compute resources, redistribution of inventory, a short-term investment, a debt strategy, penalty reductions, inventory tax minimization, etc. As one example, reinforcement learning tool 340 may project a period of excess compute resources for a time period and may suggest offering digital service tokens for sale on an exchange platform. The time value and/or amount of compute resources made available by each digital service token may be optimized by reinforcement learning tool 340. In another implementation, excess inventory may be identified, where delaying additional inventory purchases may free up cash for short-term investments. As another example, reinforcement learning tool 340 may predict that short term borrowing/debt for a future inventory payment may provide a greater overall return by freeing up resources that can be combined for short- or mid-term investments. Suggestion system 120 may provide suggestions as suggested policies 540. For example, suggestion system 120 may provide emails notifications, text messages or other notifications with details or links to suggested policies 540. Suggested policies 540 may include a single proposed action or a combination of proposed actions that may be implemented by a user/administrator to more efficiently use telecommunications carrier resources. Suggested policies 540 may include offering digital service tokens for compute resources or pursing RFPs to provide services during a particular window. As suggestion system 120 continues to collect new data from external DB 510 and in-house DB 515, reinforcement learning tool 340 may learn from inaccurate/unrealized predictions (e.g., whether or not actually implemented as suggestions) to increase accuracy. FIG. 6 provides a flow diagram of an exemplary process 600 for implementing a suggestion system for a telecommunications carrier according to an implementation. In one implementation, process 600 may be performed by suggestions system 120. In another implementation, some or all of process 600 may be performed by suggestion system 120 in conjunction with another device or group of devices in provider network 110 and/or partner system 130. Process 600 may include receiving and/or generating smart contracts (block 610) and extracting delivery timelines from the smart contracts (block 620). For example, suggestion system 120 may receive smart contracts from a private blockchain node 505, or smart contract convertor 310 may convert manual contracts to smart contracts for suggestion system 120. The smart contracts may include contract terms governing relationships between a telecommunications carrier for provider network 110 and with each of multiple partner systems 130. Digitized contract terms may be analyzed against each other to identify delivery timelines, such payment and supply chain schedules. Process 600 may further include retrieving historical vendor data and in-house procedural data (block 630) and generating an embedding layer (block 640). For example, suggestion system 120 may retrieve in-house data from in-house data DB 515 or data tools system 125. Retrieved data may include internal procedure data, historical vendor data, information that describes storage locations (e.g., address, longitude and latitude, etc.), etc. Suggestion system 120 (e.g., vendor embedding tool 320) may generate an embedding layer for the historical vendor data and in-house procedural data. The embedding layer may reduce the dimensionality of the data while preserving information in the data that can be used for modeling. Process 600 may also include predicting stagnant resource windows (650) and generating a policy suggestion for the stagnant resource windows (block 660). For example, suggestion system 120 (e.g., forecasting tool 330) may apply embeddings to build forecasts of available compute resources (e.g., configurable MEC-based compute resources and/or cloud-based compute resources), based on schedules in contract terms 525 and vendor histories (e.g., from in-house data DB 515), etc. Based on application of the embedding layer by a machine learning or artificial intelligence system, forecasting tool 330 may identify one or more stagnant windows of resources, such as compute resources that are temporarily unallocated. Suggestion system 120 (e.g., reinforcement learning tool 340) may identify suggestions to optimize/monetize available stagnant resources in one or more windows. For example, reinforcement learning tool 340 may apply data from external data DB 510 to define digital service tokens that may be offered on exchange platforms and fulfilled with stagnant compute assets. For example, reinforcement learning tool 340 may define durations, time periods, processing levels, memory limits, etc., associated with each digital service token to fit within a particular window. Suggestion system 120 may provide policy suggestions as periodic feeds (e.g., emails, notifications, text messages, etc. provided on a daily/weekly basis) to an administrator or designated recipient for the telecommunications carrier. Reinforcement learning tool 340 may continue to assess new data in in-house data DB 515 and external data DB 510 to learn how to utilize future advances or declines in resources. As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc. The foregoing description of embodiments provides illustration, but is not intended to be exhaustive or to limit the embodiments to the precise form disclosed. Accordingly, modifications to the embodiments described herein may be possible. For example, while examples described herein have been described in the context of operations of telecommunication service provider, in other implementations, policy suggestion processes may take place within other contexts (e.g., a service provider/enterprise relationship, etc.). Thus, various modifications and changes may be made thereto, and additional embodiments may be implemented, without departing from the broader scope of the invention as set forth in the claims that follow. The description and drawings are accordingly to be regarded as illustrative rather than restrictive. The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations. In addition, while series of blocks have been described with regard to the processes illustrated in FIG. 6, the order of the blocks may be modified according to other embodiments. Further, non-dependent blocks may be performed in parallel. Additionally, other processes described in this description may be modified and/or non-dependent operations may be performed in parallel. Embodiments described herein may be implemented in many different forms of software executed by hardware. For example, a process or a function may be implemented as “logic,” a “component,” or an “element.” The logic, the component, or the element, may include, for example, hardware (e.g., processor 220, etc.), or a combination of hardware and software (e.g., software 235). Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented. Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements. Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 220) of a device. A non-transitory storage medium includes one or more of the storage mediums described in relation to memory 230. To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information. No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method, comprising:
receiving, by a network device, multiple smart contracts governing relationships between a telecommunications carrier and partner entities;
extracting, by the network device, delivery timelines from the multiple smart contracts;
generating, by the network device, an embedding layer based on historical vendor data and in-house procedural data; and
predicting, by the network device, one or more windows of stagnant resources in the delivery timelines, based on application of the embedding layer by a machine learning or artificial intelligence system; and
generating, by the network device, a policy suggestion to optimize stagnant resources during the one or more windows.

2. The method of claim 1, wherein predicting the one or more windows of stagnant resources comprises:
projecting a period of surplus inventory.

3. The method of claim 1, wherein predicting the one or more windows of stagnant resources comprises:
allowing for internal processing timeframes based on the in-house procedural data.

4. The method of claim 1, wherein the multiple smart contracts are included in different private distributed ledgers for each partner entity.

5. The method of claim 1, wherein generating the policy suggestion comprises:
retrieving requests for services,
identifying compute resources available during the one or more windows, and
selecting, from the requests for services, an option with a highest guaranteed return during the one or more windows.

6. The method of claim 1, wherein generating the policy suggestion comprises:
identifying windows of stagnant resources in multiple institutions,
generating a consolidation plan among the multiple institutions to temporarily consolidate at least some of the stagnant resources, and
selecting a service option for the consolidated stagnant resources.

7. The method of claim 1, wherein extracting the delivery timelines comprises:
identifying invoice dates, payment periods, and penalty clauses.

8. The method of claim 1, wherein generating the policy suggestion comprises:
identifying a time value or amount of compute resources for digital service tokens to be offered during the one or more windows.

9. A network device, comprising:
one or more processors configured to:
receive multiple smart contracts governing relationships between a telecommunications carrier and partner entities;
extract delivery timelines from the multiple smart contracts;
generate an embedding layer based on historical vendor data, in-house procedural data; and
predict one or more windows of stagnant resources in the delivery timelines; and
generate a policy suggestion to optimize stagnant resources during the one or more windows.

10. The network device of claim 9, wherein, when predicting the one or more windows of stagnant resources, the one or more processors are further configured to:
project a period of surplus inventory.

11. The network device of claim 9, wherein, when predicting the one or more windows of stagnant resources, the one or more processors are further configured to:
account for internal processing timeframes based on the in-house procedural data.

12. The network device of claim 9, wherein the multiple smart contracts are included in different private distributed ledgers for each partner entity.

13. The network device of claim 9, wherein, when generating the policy suggestion, the one or more processors are further configured to:
retrieve requests for services,
identify compute resources available during the one or more windows, and
select, from the requests for services, an option with a highest guaranteed return during the one or more windows.

14. The network device of claim 9, wherein, when generating the policy suggestion, the one or more processors are further configured to:
identify windows of stagnant resources in multiple institutions, and
generate a consolidation plan among the multiple institutions to temporarily consolidate at least some of the stagnant resources.

15. The network device of claim 9, wherein, when generating the policy suggestion, the one or more processors are further configured to:
identify a time value or amount of compute resources for digital service tokens to be offered during the one or more windows.

16. The network device of claim 9, wherein, when extracting the delivery timelines, the one or more processors are further configured to:
identify invoice dates, payment periods, and penalty clauses.

17. A non-transitory computer-readable medium containing instructions executable by at least one processor, the one or more instructions for:
receiving, by a network device, multiple smart contracts governing relationships between a telecommunications carrier and partner entities;
extracting, by the network device, delivery timelines from the multiple smart contracts;
generating, by the network device, an embedding layer based on historical vendor data and in-house procedural data; and
predicting, by the network device, one or more windows of stagnant resources in the delivery timelines, based on application of the embedding layer by a machine learning or artificial intelligence system; and
generating, by the network device, a policy suggestion to optimize stagnant resources during the one or more windows.

18. The non-transitory computer-readable medium of claim 17, wherein the instructions for generating the policy suggestion comprises further comprise instructions for:
retrieving requests for services,
identifying compute resources available during the one or more windows, and
selecting, from the requests for services, an option with a highest guaranteed return during the one or more windows.

19. The non-transitory computer-readable medium of claim 17, wherein the instructions for generating the policy suggestion comprises further comprise instructions for:
identifying windows of stagnant resources in multiple institutions, and
generating a consolidation plan among the multiple institutions to temporarily consolidate at least some of the stagnant resources.

20. The non-transitory computer-readable medium of claim 17, wherein the multiple smart contracts are included in different private distributed ledgers for each partner entity.
